(19) United States
(12) Patent Application Publication
(10) Pub. No.: US 2006/0156845 A1
(43) Pub. Date: Jul. 20, 2006

(54) Self-Retaining Recirculating Ball-Worm and Gear Device

(75) Inventor: Davy Tong, Windsor, CA (US)

Correspondence Address: DAVY TONG, 5520 ENCINITA AVE., TEMPLE CITY, CA, 91780, US

(73) Assignee: Davy Tong, Windsor, CA (US)

(21) Appl. No.: 10/905,285

(22) Filed: Dec. 23, 2004

(51) Int. Cl. F16H 1/16

(52) U.S. Cl. 74/425

(57) ABSTRACT

A self-retaining ball-worm and gear mechanism is provided to facilitate the rotational transmission of motion between two orthogonal but non-intersecting axes. A circuit of balls introduced as rolling elements indirectly couples the worm and gear, and eliminates the sliding friction characteristic of classical worm and gear mechanisms. The mechanism comprises a ball-worm (200), gear (202), and axial supports or housing (204). The ball-worm defines the ball circulation path. The worm helix is designed to retaining the balls such that no additional ball-retaining components are necessary. Magnetism may optionally or additionally be employed to attract the metal balls to the worm body, further enhancing ball self-retention. The gear comprises a plurality of grooves designed to engage the helix of balls on the worm. The path of the worm helix is mathematically accurate so that balls simultaneously engage multiple gear grooves, increasing the torque load capabilities of the device.

### BACKGROUND OF THE INVENTION

1. Field of Invention

The present invention relates to mechanical rotational-to-rotational transmissions, specifically to worm and gear transmissions.

2. Prior Art

The classical worm and gear mechanism represented in FIG. 1 is commonly used for speed reduction, rotational positioning, motion control, and other rotational-to-rotational transmission applications. The classic mechanism consists of a worm 100, gear 102, and axial support components (not shown) such as bearings or bushings. Sliding motion between the helix of worm 100 and teeth of gear 102 cause the gear to rotate as the worm is rotated. The sliding friction causes the mechanism to suffer from premature wear and inefficient power conversion. Backlash has also been especially problematic in such mechanisms. Several approaches that utilize dual gearing and anti-backlash springs only eliminates the backlash for a narrow torque range. The motion of the mechanism is also irreversible; that is, the worm can drive the gear, but the gear cannot drive the worm.

To overcome the limitations of the classical worm and gear mechanism, several solutions have been proposed that replace the sliding friction with rolling friction via a circuit of rolling spherical balls. FIGS. 2 and 3 provide typical examples of such devices known as ball-worm and gear mechanisms, or simply ball-worm transmissions. In the modified mechanism a ball-worm 120 is indirectly coupled to a gear 122 via a plurality of circulating balls 124.

The introduction of balls has caused the assembly process of ball-worm transmissions to be cumbersome or awkward. Because balls tend to scatter when unconstrained, ball installation during assembly is difficult. Special tooling or skilled labor is often required. The awkward assembly process also causes replacement of worn-out balls and other parts to be likewise burdensome. Consequently, the ball-worm transmission is more costly to manufacture and maintain.

The introduction of balls as rolling elements also necessitated a means for constraining, retaining, confining, or otherwise preventing them from straying during normal operation. A ball-retainer 126, or similar mechanism, was introduced to at least partially fulfill this need. As shown in FIGS. 2 and 3, ball-retainer 126 externally surrounds the ball-worm preventing the balls from straying or scattering. In some prior-art ball-worm transmissions, the ball-retainer 126 also provided the recirculation path for the balls. Subsequently, the ball-worm transmission is more complex than its classical predecessor, which needed no such ball-retaining mechanism. The classical mechanism was also simple to assemble. The ball-retainer also increases overall weight and size. In certain applications, such as vehicle transmission systems, increased weight and size can be a considerable disadvantage. Providing a reliable and simple means for ball installation, retention, containment, and recirculation has been arguably one of the greatest challenges of attaining a robust ball-worm transmission.

All known prior-art ball-worm transmissions have utilized a ball-retainer component 126 of some kind. Although different inventors use different nomenclature to designate the ball-retainer, their function and purpose has remained constant: to constrain, retain, or otherwise confine the balls and prevent them from straying from their circuit path. U.S. Pat. No. 5,090,266 to Otsuka (1992) discloses a “rotation transmitter” that uses “ball guides” in combination with an “outer guide” to achieve an improvement in ball circulation path. U.S. Pat. No. 5,373,753 to Toyomasa (1994) describes a power transmission device that uses “frame rings” mounted on the worm at both ends to prevent the balls from floating out of the groove of the worm. U.S. Pat. No. 5,816,103 to Huang (1998) discloses a ball-worm and gear device with a “housing” that is encased externally to constrain the balls to the helical channel of the worm. The prior-art suggests that an external ball-retaining mechanism surrounding the ball-worm is necessary for the proper functioning of the ball-worm transmission. This suggestion is consistent even in more recent publications. U.S. Patent Application Publication 2003/0115981 (European Patent EP1454078) to Stoianovici et al (2003) discloses a ball-worm transmission that comprises an “outer race” with “internal revolute hyperboloidal surface” to constrain and maintain contact with the balls along the passive path.

Increased complexity, cost, weight, and size are not the only disadvantages of introducing the ball-retainer component. The ball-retainer also accelerates wear. Surfaces of the balls will wear only when in contact with other surfaces. The ball-retainer must maintain contact with the balls in order to constrain them, thereby wearing the balls and reducing the useful life of the device. It would be greatly advantageous if ball installation, retention, confinement, and recirculation could be accomplished without the use of an extraneous ball-retaining component.

### OBJECTS AND ADVANTAGES

Accordingly, in addition to the advantages of ball-worm and gear transmissions in general, several objects and advantages of the present invention are:
(1) To eliminate the sliding friction characteristic of the classical worm and gear mechanism, and replace it with rolling friction via a circuit of rolling balls.
(2) To provide a durable and power efficient worm and gear transmission.
(3) To provide a worm and gear transmission with minimal or no backlash.
(4) To provide a worm and gear mechanism that can be easily converted to reverse-drivable and non-reverse-drivable configurations.
(5) To provide an improved ball-worm and gear transmission that obviates the need for any extraneous ball-retaining components, or similar mechanisms, to reduce complexity, production cost, weight, and size.
(6) To provide an improved ball-worm and gear transmission requiring fewer parts than the prior art, but without loss of capability or functionality.
(7) To provide a ball-worm and gear transmission with the ball circuit path entirely defined by the ball-worm.
(8) To provide a ball-worm and gear transmission with a ball circuit path that is smooth and reliable, facilitating ball circulation and reducing wear.
(9) To provide a ball-worm and gear transmission with a ball-worm that is self-retaining; that is, capable of constraining the balls to itself without the assistance of any additional components or mechanisms.
(10) To provide an improved ball-worm and gear transmission with reduced cumulative ball contact surface area to reduce wear and prolong the device's useful life.
(11) To provide an improved ball-worm and gear transmission that is convenient to assemble, disassemble, and reassemble, minimizing assembly and maintenance costs.
   Further objects and advantages of the present invention will become apparent from a consideration of the drawings and ensuing description.

### SUMMARY

In accordance with the present invention, a ball-worm transmission comprises a self-retaining ball-worm, gear, and axial supporting mechanisms. In the drawings, closely related figures have the same numeric prefix but different alphabetic suffixes.

### DRAWINGS—FIGURES

FIG. 1 shows a representative classical worm and gear mechanism of the prior art.

FIG. 2 shows a typical ball-worm transmission of the prior art, reproduced from U.S. Pat. No. 5,090,266 to Otsuka (1992).

FIG. 3 provides a more recent example of a ball-worm transmission of the prior art, reproduced from European Patent EPI 454078 to Stoianovici (2003).

FIGS. 4A to 4C show several overall views of the present invention.

FIGS. 5A to 5C show several views of the present invention with its housing omitted.

FIG. 6 shows an enlarged view of the ball-worm and gear.

FIG. 7 shows the gear with circuit of balls. All other components are omitted.

FIGS. 8A to 8C show the gear and circuit of balls, with FIG. 8C pointing out the balls in their various active, passive and recirculating states denoted by the letters X, P, and C respectively.

FIGS. 9A to 9B illustrate the assembly of and various subcomponents of the ball-worm.

FIGS. 10A and 10B show 3-dimensional views of the worm collar.

FIGS. 11A to 11C reveal the cross-sectional profile of the worm helix.

FIGS. 12A and 12B provide alternative cross-sectional profiles for the worm helix.

FIG. 13 shows a general outline of the ball-worm and defines its reference coordinate system.

FIG. 14 shows a top-down view with general outline of the ball-worm and gear to define its crucial parameters and variables.

FIG. 15 provides a representative plot of the path of the worm helix.

FIGS. 16A to 16B illustrate how balls transition to/from passive and recirculating states.

FIG. 17 shows an enlarged view of the worm shaft and balls in the recirculating state.

FIG. 18 shows an enlarged view of the worm shaft.

FIGS. 19A to 19C provide cross-sectional profile of the gear grooves.

FIG. 20 shows an alternative cross-sectional profile for the gear grooves.

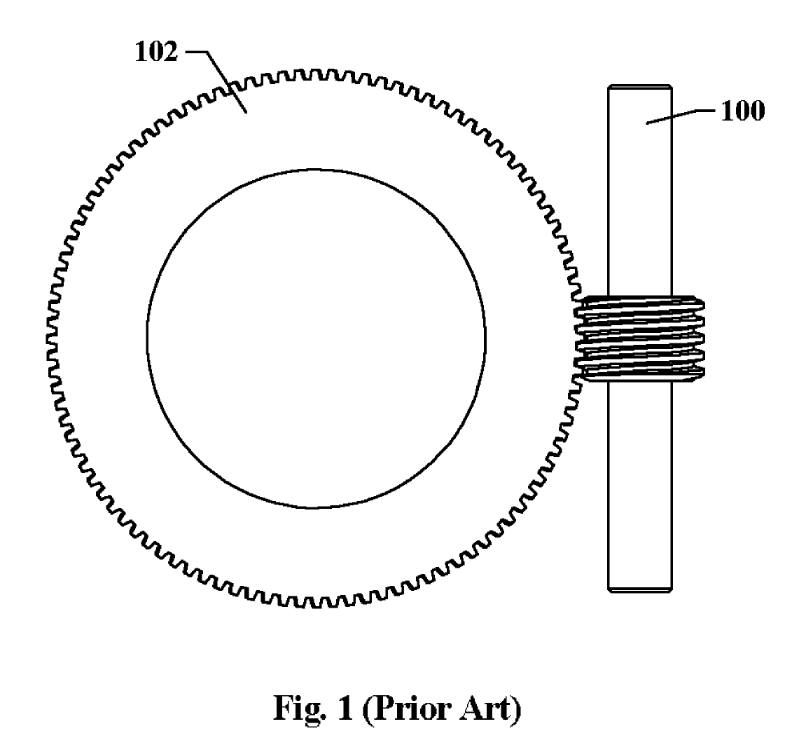

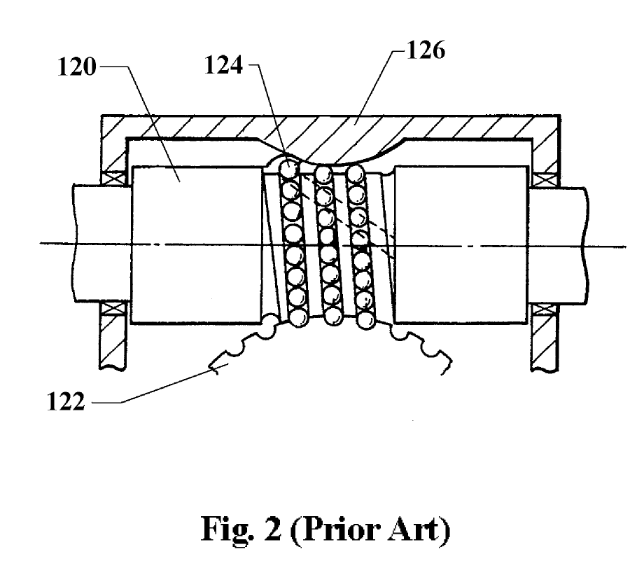

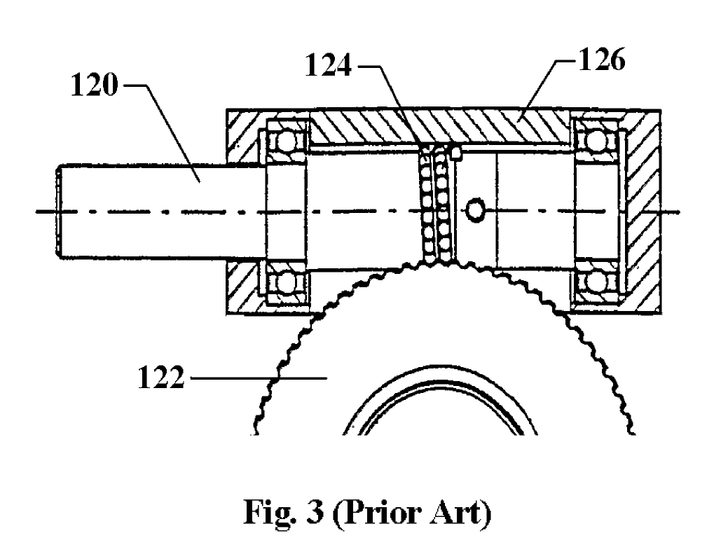

### DRAWINGS—REFERENCE NUMBERALS

### Reference Numerals for the Prior Art

100 Worm of classical worm and gear mechanism of the prior art
102 Gear of classical worm and gear mechanism the prior art
120 Ball-worm of the prior art
122 Gear of ball-worm transmission of the prior art
124 Balls of the prior art
126 Ball-retainer component of the prior art

### Reference Numerals for the Present Invention

200 Self-retaining ball-worm
202 Gear
204 Housing
220 Worm shaft
222 Worm collar
224 Ball(s)
226 Plug
240 Gear groove(s)
242 Dashed circular curve
260 Ball installation port
262 Worm helix
264 Alignment pocket
266 Transitional fillet
268 Precision rolling surface(s)
270 Clearance surface(s)
272 Undercut surface(s)
274 Transitional port
276 Hourglass shaped surface of ball-worm
278 Worm axis
300 Alignment boss
302 Recirculation channel
320 Active ball(s)
322 Passive ball(s)
324 Recirculating ball(s)

### DETAILED DESCRIPTION

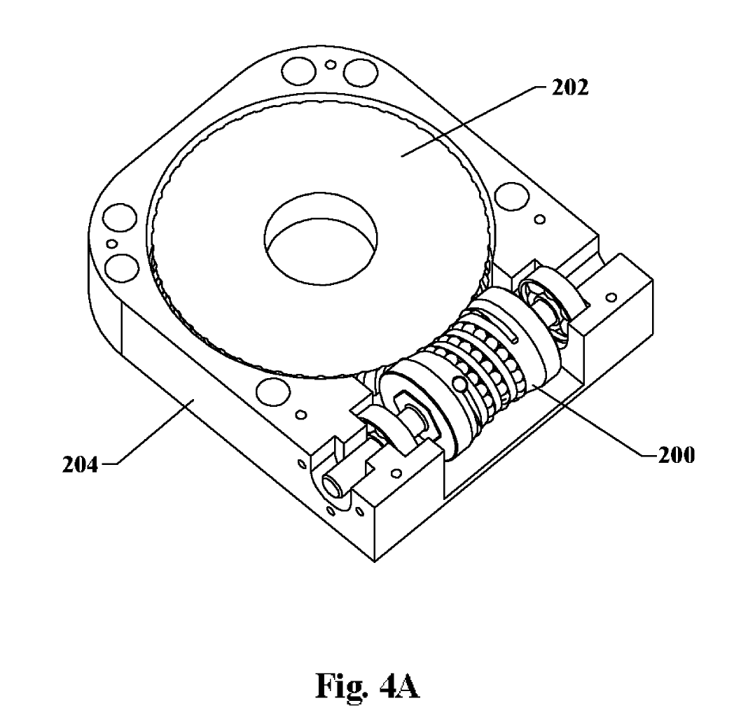

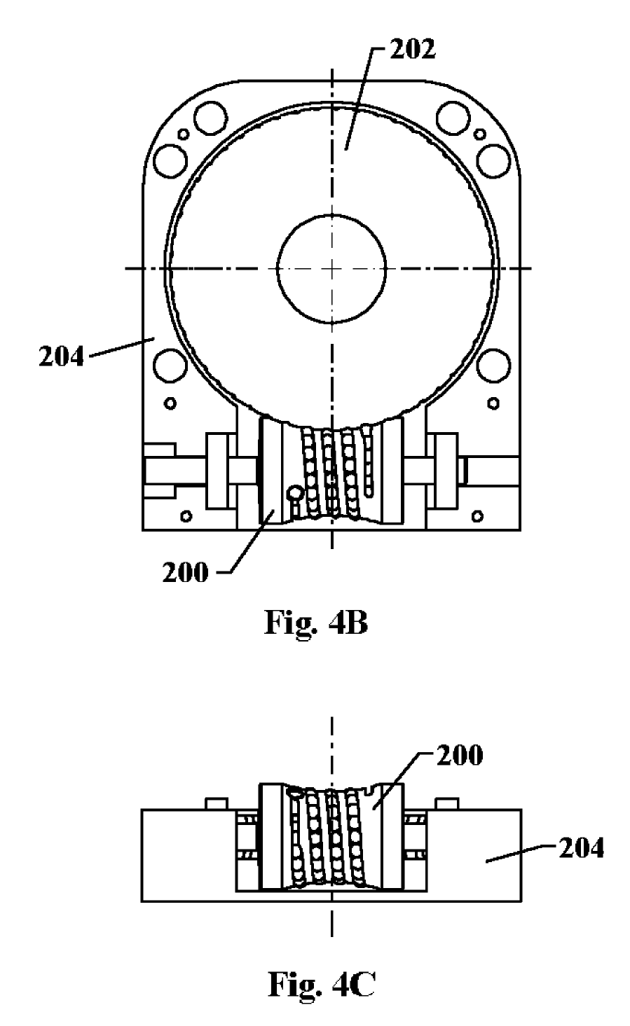

FIGS. 4A to 4C present several overall views of the self-retaining recirculating ball-worm and gear device. The device comprises a self-retaining ball-worm 200, gear 202, and housing 204. Housing 204 is designed to enclose and axially support the internal components of ball-worm 200 and gear 202. Bearings, bushings, or other support mechanisms may be included in housing 204 to axially support and restrict ball-worm 200 and gear 202 to their respective axes of rotation.

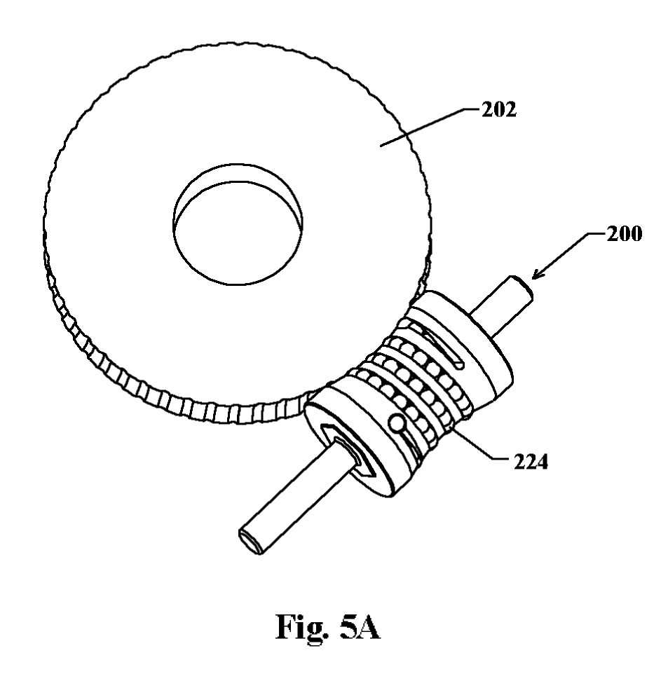

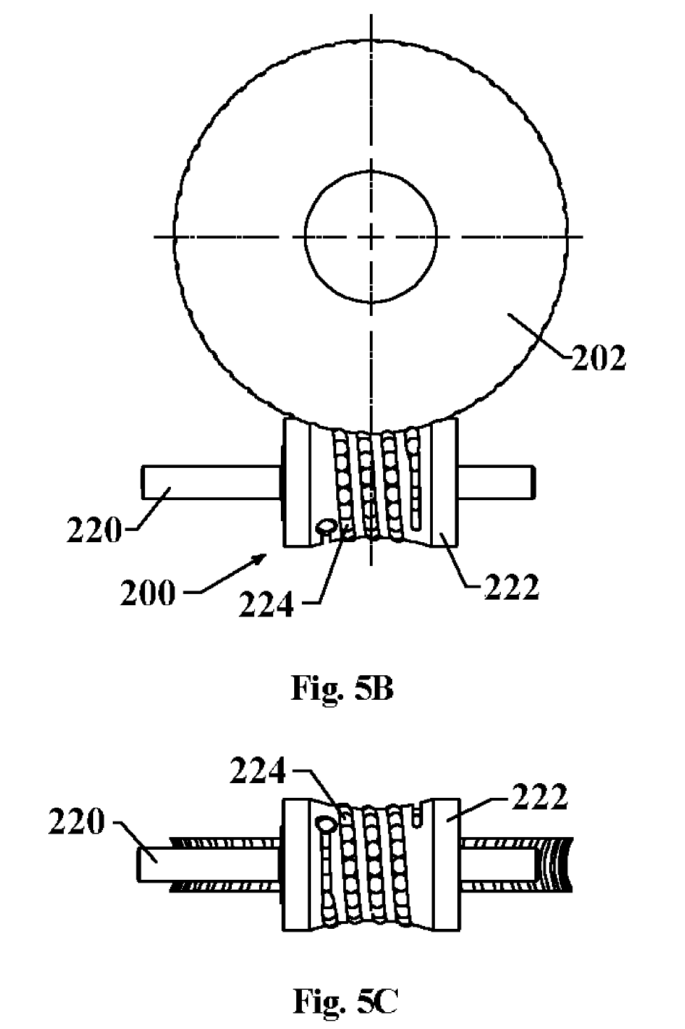

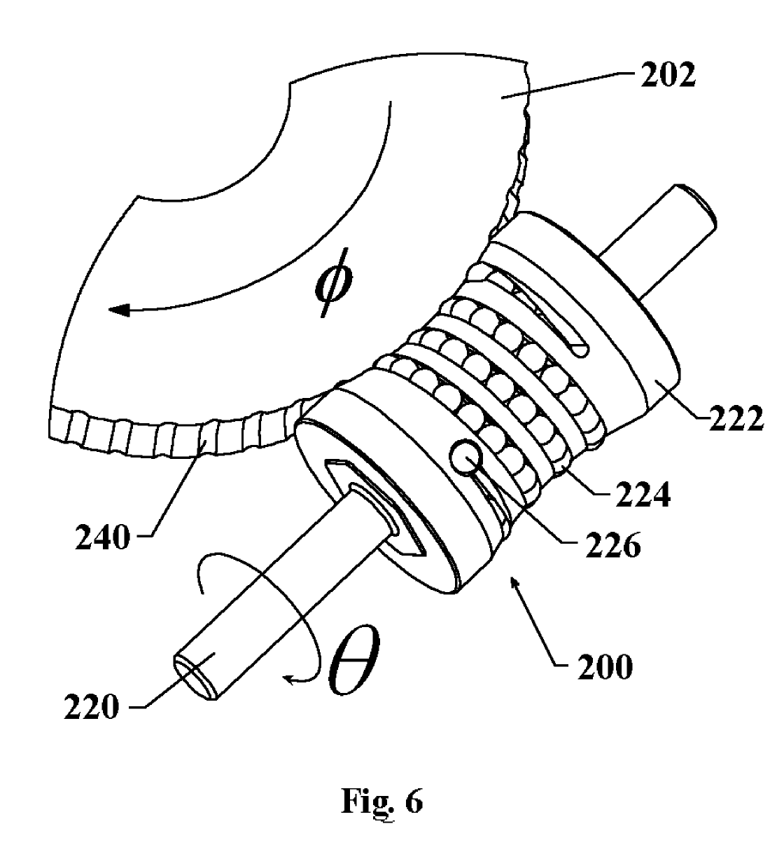

FIGS. 5A to 5C and FIG. 6 show several views of the device with housing 204 omitted. The axis of ball-worm 200 and axis of gear 202 are orthogonal but non-intersecting. The ball-worm comprises a worm shaft 220, worm collar 222, plug 226, and plurality of balls 224. The gear has a plurality of gear grooves 240 separated at periodic angular intervals which are designed to engage the balls 224 of the ball-worm. Worm shaft 220 and worm collar 222 are rigidly fastened together so that rotation of one causes the same rotation of the other. Worm shaft 220 and worm collar 222 together define the circuit path for the balls. The ball-worm is designed to retain the balls without requiring any additional or external components. Hence, ball-worm 200 is said to be self-retaining. That is, the balls will adhere to the body of the ball-worm even when the worm is removed from the rest of the assembly. Thus, the ball-worm can be conveniently replaced as a complete unit without the possibility of inadvertently scattering the balls during assembly or disassembly.

The self-retaining feature of ball-worm 200 is crucial for its low-cost production and maintainability. Prior-art ball-worm transmissions are not self-retaining, and require external components to constrain the balls. Therefore, the balls easily scatter during assembly or disassembly, causing replacement of worn-out parts to be cumbersome. Self-retention allows for convenient assembly and replacement of parts.

Rotation of the ball-worm causes its helix of balls to circulate. Balls firmly engaged or meshed between the worm helix and gear groove serve to couple the gear to the worm. In FIG. 6 the rotational displacement of the ball-worm and gear are denoted as θ and φ respectively. Each complete turn of the ball-worm causes the gear to advance by one gear groove. Hence
θ=Nφ
where N is the total number of gear grooves. N is also the transmission ratio, or gear ratio, of the device. The helix of the ball-worm is mathematically accurate so that multiple balls engage multiple gear grooves simultaneously. Simultaneous engagement of multiple grooves enhances the gear-to-worm coupling rigidity. Increased gear-to-worm coupling rigidity means that the device can endure greater applied torques without sustaining permanent damage to its internal components. The use of balls to indirectly couple the gear and worm eliminates, or otherwise dramatically reduces, backlash. Its non-backlash characteristics are maintained when at least one or more balls are firmly engaged between the worm helix and gear groove. As the balls wear through prolonged use, they will no longer be able to firmly engage the worm helix and gear grooves. If one of the balls wears faster than the others, simultaneous multiple groove engagement ensures that there are “backup” balls that are firmly locked between the gear groove and worm helix. Thus, the mathematically accurate worm helix is also intended to prolong the useful life of the device.

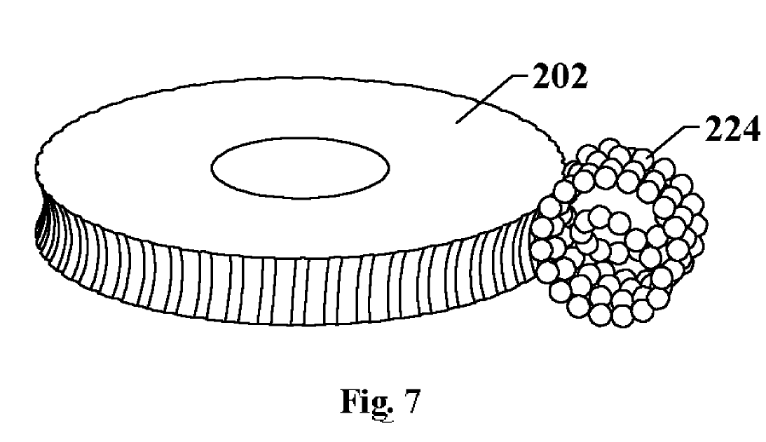

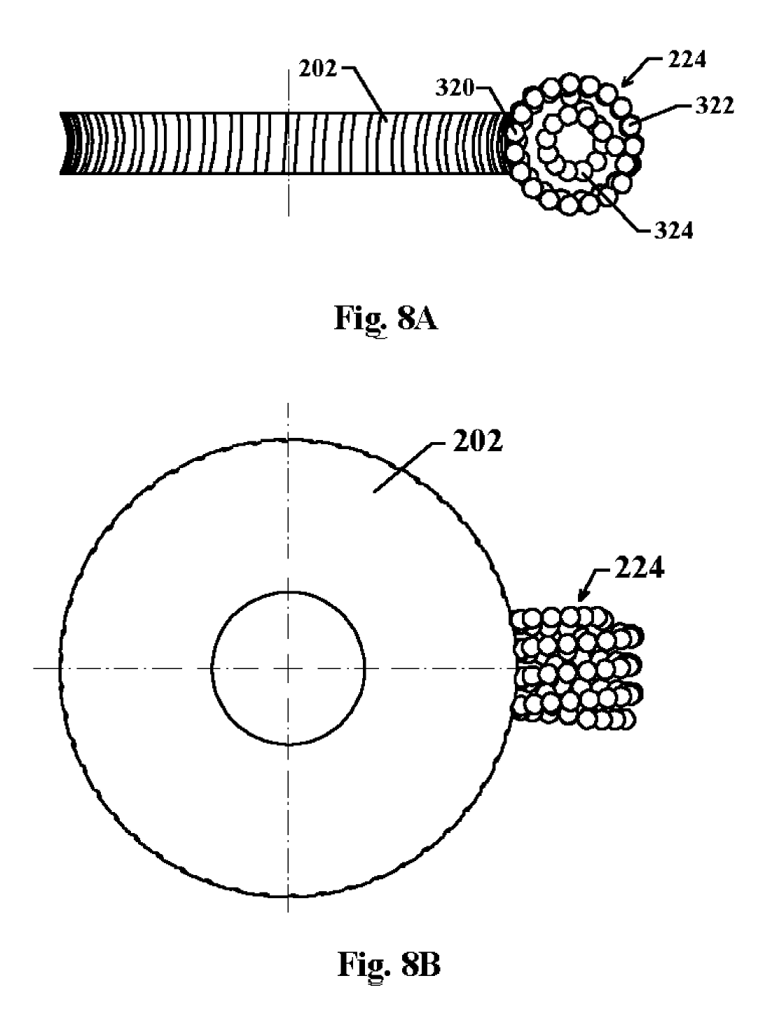

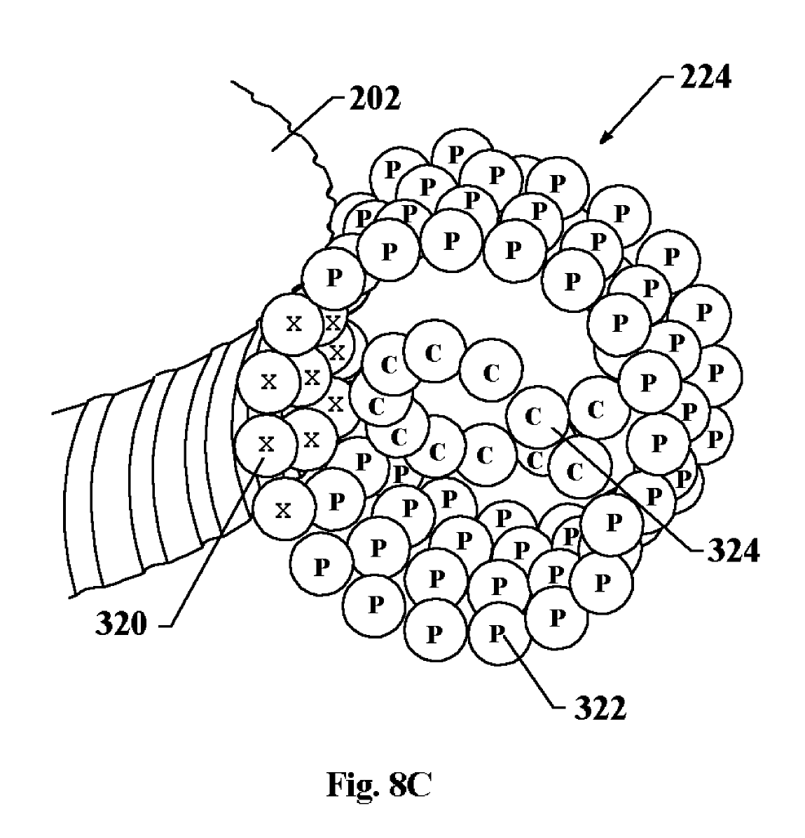

FIG. 7 shows gear 202 with closed circuit of balls 224. For clarity, all other parts have been omitted. A ball traversing along the closed circuit path is said to be in one of three states: 1) active, 2) passive, or 3) recirculating. FIGS. 8A and 8B show front and top views of the balls with gear. FIG. 8C points out the balls with their various states. In FIG. 8C, active balls 320 are marked with an “X”, passive balls 322 are marked with a “P”, and recirculating balls 324 are labeled “C”. Some of the balls in the FIG. 8C are hidden behind other balls. Only balls that are not hidden are labeled with “X”, “P”, or “C”. Balls that are engaged between the worm helix and gear groove are defined to be in the active state. Active balls 320 serve to couple the gear to the ball-worm. Balls located along the worm helix but not currently engaged with any of the gear groves are defined to be passive. Balls located inside the ball-worm serve to close the circuit of balls and are said to be recirculating. Recirculating balls traverse in the opposite direction than the rest of the balls, and would normally otherwise be hidden from view. Note that the majority of balls at any instant are passive. In prior-art ball-worm transmissions, these passive balls must maintain contact with a ball-retaining component that surrounds the worm. Hence, eliminating the ball-retainer would significantly reduce the cumulative ball contact surface area and decrease wear and tear.

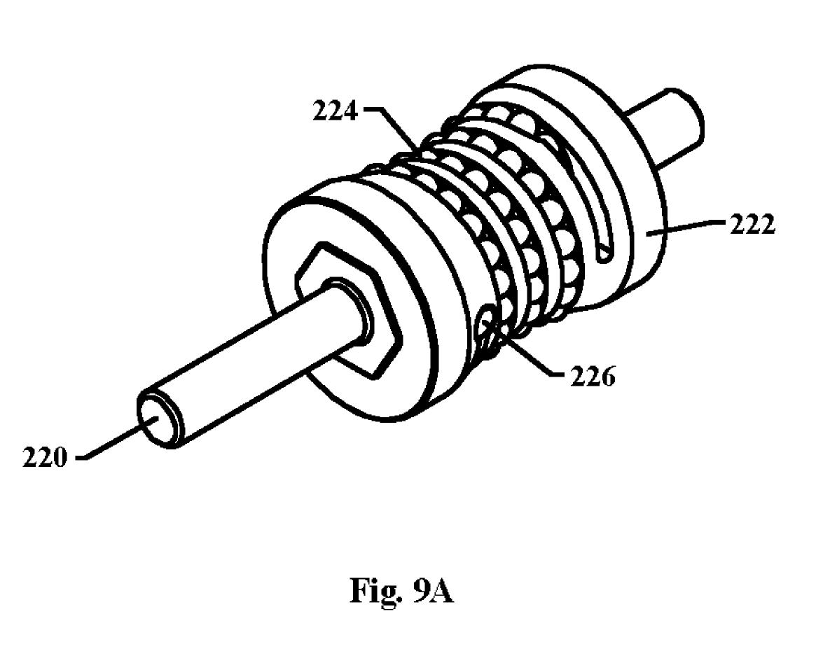

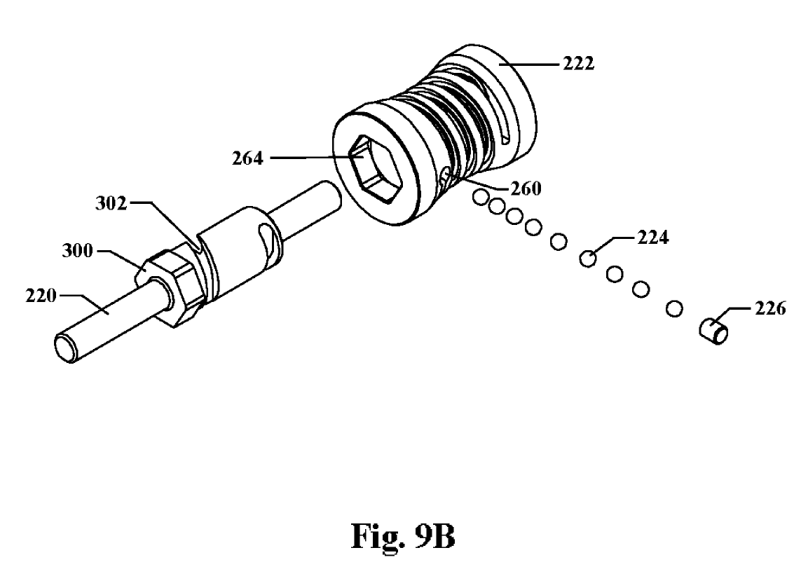

A fully-assembled self-retaining ball-worm is shown in FIG. 9A. An exploded view with its necessary subcomponents is shown in FIG. 9B. The ball-worm comprises worm shaft 220, worm collar 222, plurality of balls 224, and plug 226. Worm shaft 220 and worm collar 222 are concentrically and rigidly fastened. An alignment pocket 264 on worm collar 222 and alignment boss 300 on worm shaft 220 are used for mating and aligning purposes during fastening. Although alignment pocket 264 and boss 300 are depicted as hexagonal in the Fig, they can alternatively be of any geometry that will adequately mate and align the two parts. Additional fasteners such as pins, screws, or dowels may optionally be used if more fastening strength is required. A helical channel 302 on the worm shaft defines the ball recirculation path. A ball installation port 260 on worm collar 222 provides an opening for balls to be conveniently installed into the ball-worm. Balls are inserted serially. The worm helix located on collar 222 is designed to be self-retaining. Therefore, the balls will not fall out of the helix as they are inserted into the ball-worm. After all balls have been inserted, plug 226 seals installation port 260, preventing any balls from traveling back out of the port. The plug can be a dowel, set screw, or any appropriate component that will adequately seal the entrance of ball installation port 260.

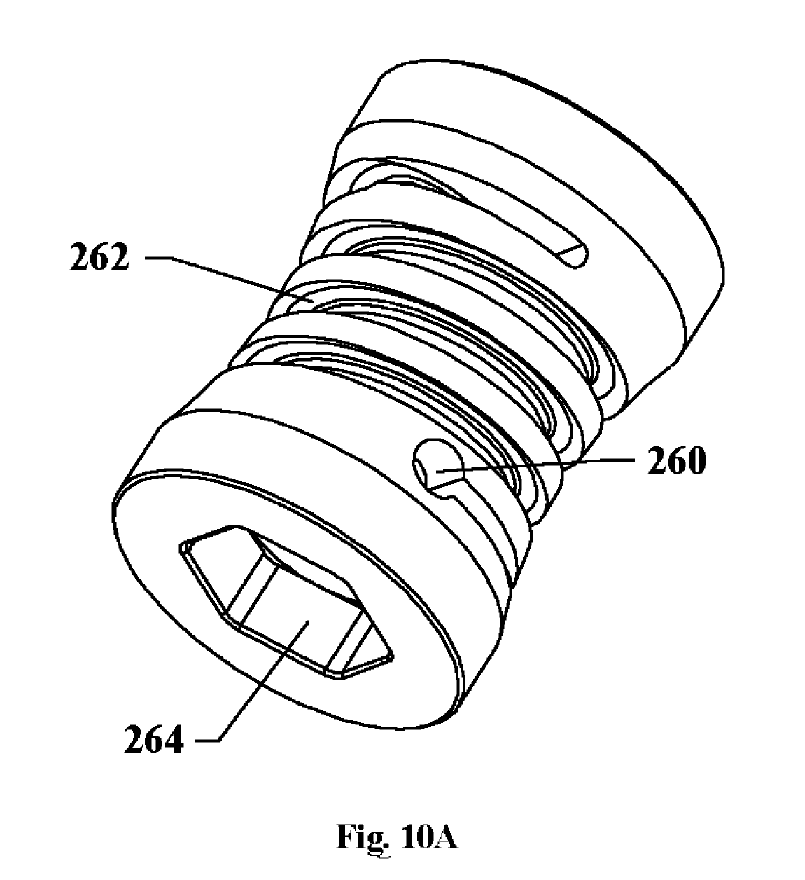

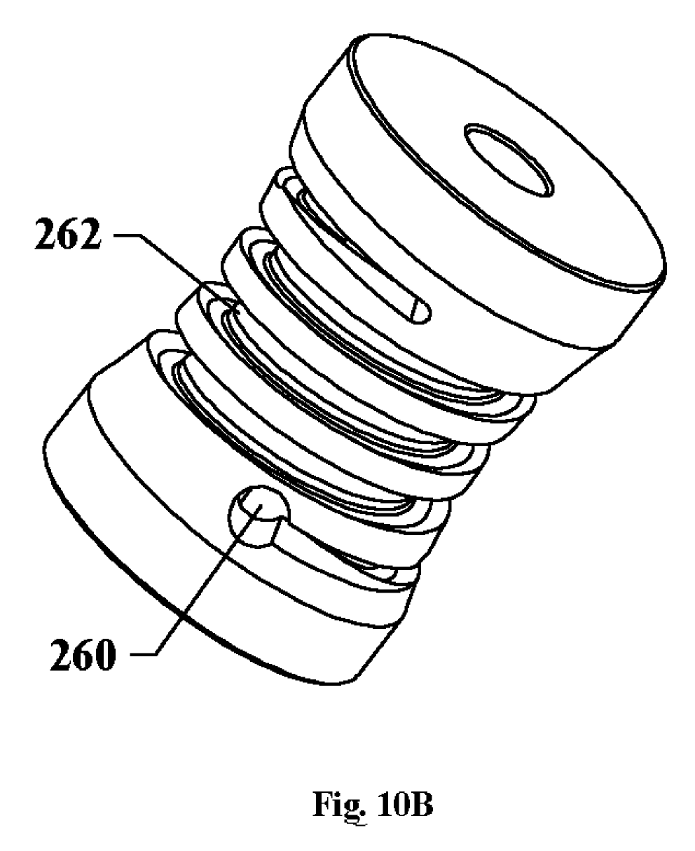

Enlarged 3-dimensional views of worm collar 222 are shown in FIGS. 10A and 10B. Worm helix 262, ball installation port 260, and alignment pocket 264 are particularly pointed out in these figures.

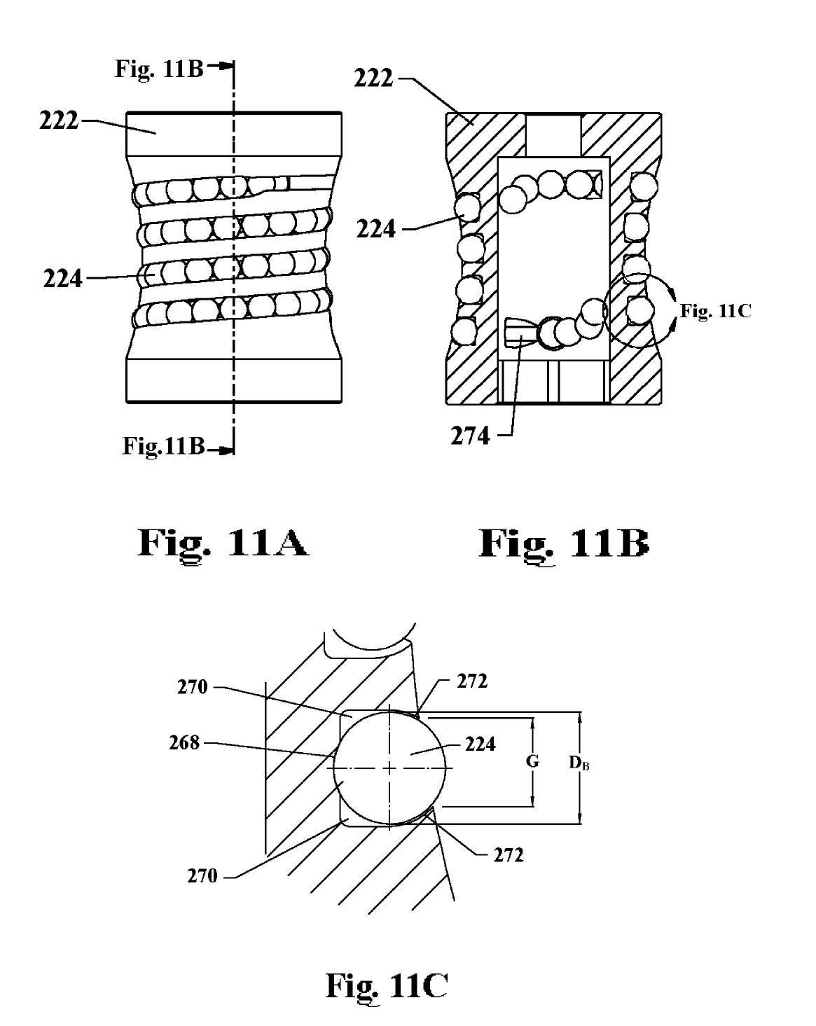

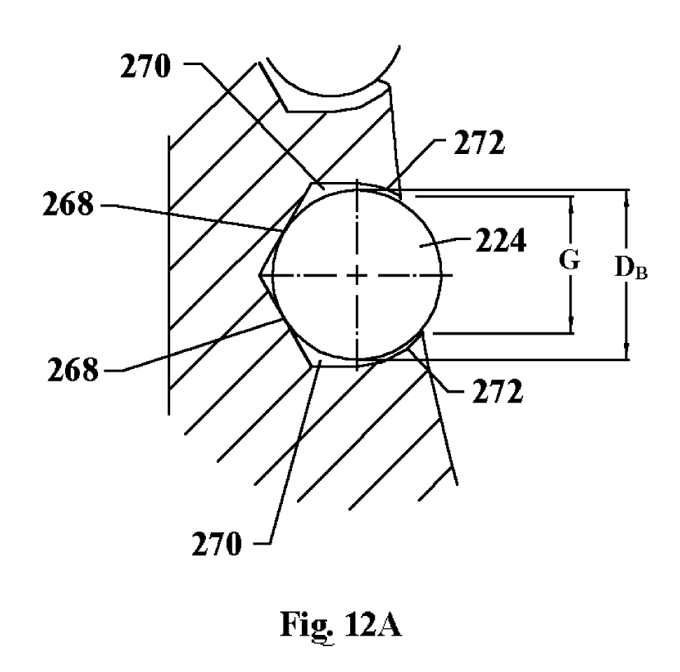

The cross-sectional profile of the worm helix is shown in FIGS. 11A through 11C. FIG. 11C shows an enlarged detailed cross-sectional view of the worm helix with representative ball 224. The cross-sectional profile comprises a precision rolling surface 268, clearance surfaces 270, and undercut surfaces 272. Precision rolling surface 268 provides the rolling surface for the balls to engage the worm helix. Clearance surfaces 270 provide a small but finite amount of space (usually between 0.002 to 0.0010 inches from the ball surface) around the ball so that the balls are able to roll freely as they traverse the helix. If there were no clearance, the balls would be jammed or have great difficulty traversing the helix. Undercut surfaces 272 partially enclose around the balls to retain and constrain them to the ball-worm. The undercut surfaces provide the ball-worm its self-retaining capabilities. A small but finite amount of clearance also exists between the undercut surfaces and the balls. In FIG. 11C, G is the groove gap of the worm helix, and D_{B} is the ball diameter. The relationship
0<G<D_{E}
is one of several conditions that must be satisfied for a properly functioning ball-worm. Additionally, the centers of the balls must be embedded below the outer surface of worm collar 222. Yet, the balls must also partially protrude out of the ball-worm so that they can engage the gear grooves. Self-retention obviates the need for any extraneous ball-retaining components, reducing complexity and production cost. A ball-retaining component that externally surrounds the worm must maintain contact with the balls in order to retain them. Eliminating such a component decreases the cumulative ball contact surface area, which leads to decreased wear of the balls. Thus, the self-retaining ball-worm has improved durability characteristics over its non-self-retaining predecessors.

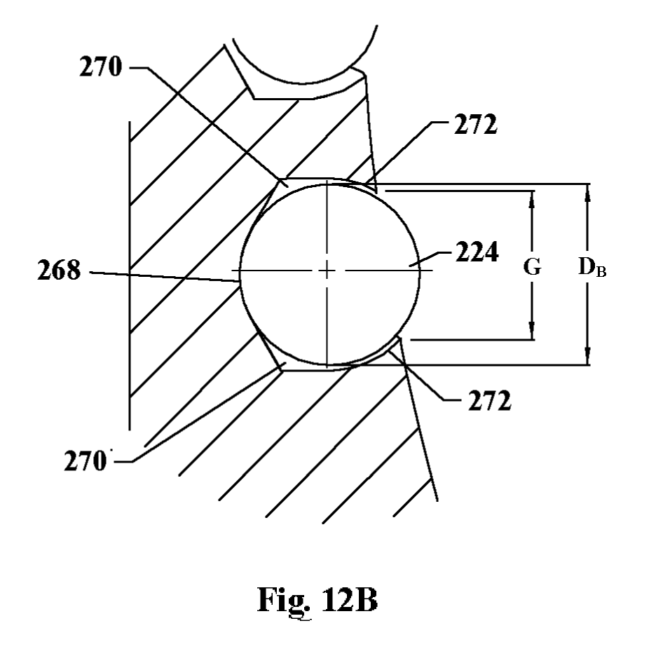

FIGS. 12A and 12B show alternative cross-sectional helix profiles that also satisfy the conditions necessary for self-retention. The cross-sectional profile shown in FIG. 12B is presently preferred because of its minimized helix-to-ball contact surface area.

A variety of methods exists for fabricating a ball-worm with helix comprising undercut surface profiles as described above. One method is to use a 4-Axis CNC milling machine with custom undercutting end mills. The 4^{th} axis of the milling machine is required to be a rotary axis. Harvey Tool Company of Topsfield, Mass. (web: www.harveytool.com) is among one of the custom toolmakers capable of supplying the necessary undercutting end mills. If more precision is required, the ball-worm may be rough-milled initially with additional post-grinding process. Other approaches may entail a combination of metal injection or casting with a post-machining process.

Magnetism may additionally be used to assist the self-retention of balls. If balls 224, for instance, are composed of a ferromagnetic material, worm collar 222 and/or worm shaft 220 may optionally be made of a permanently magnetic material to attract the balls. A combination of magnetism and a self-retaining helix profile design is presently preferred.

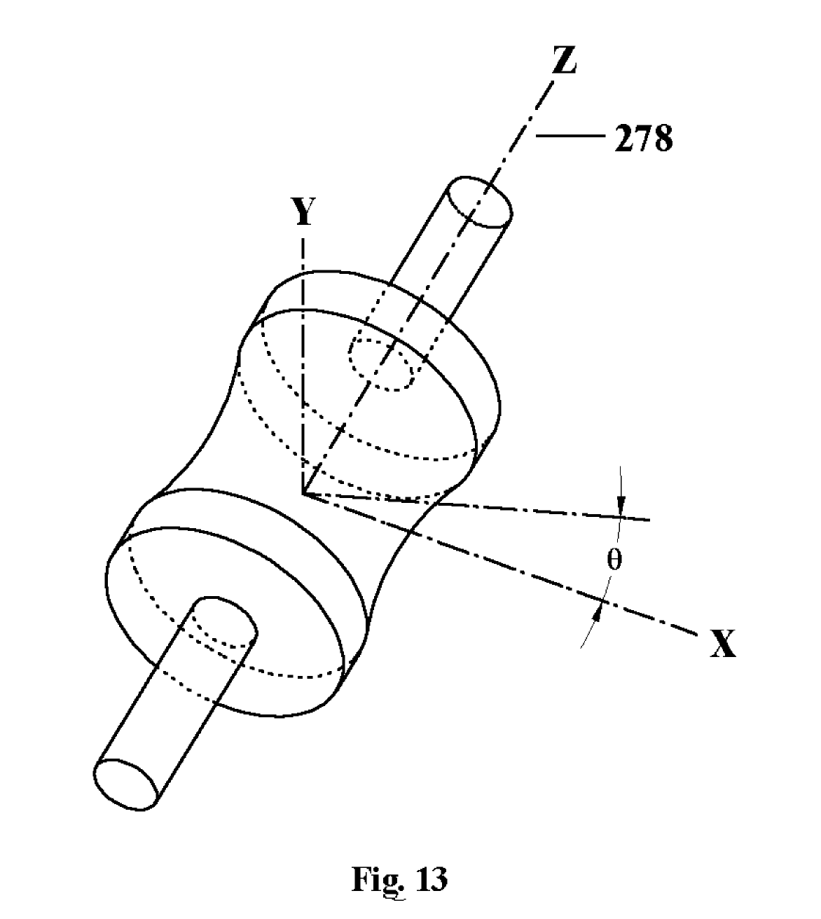

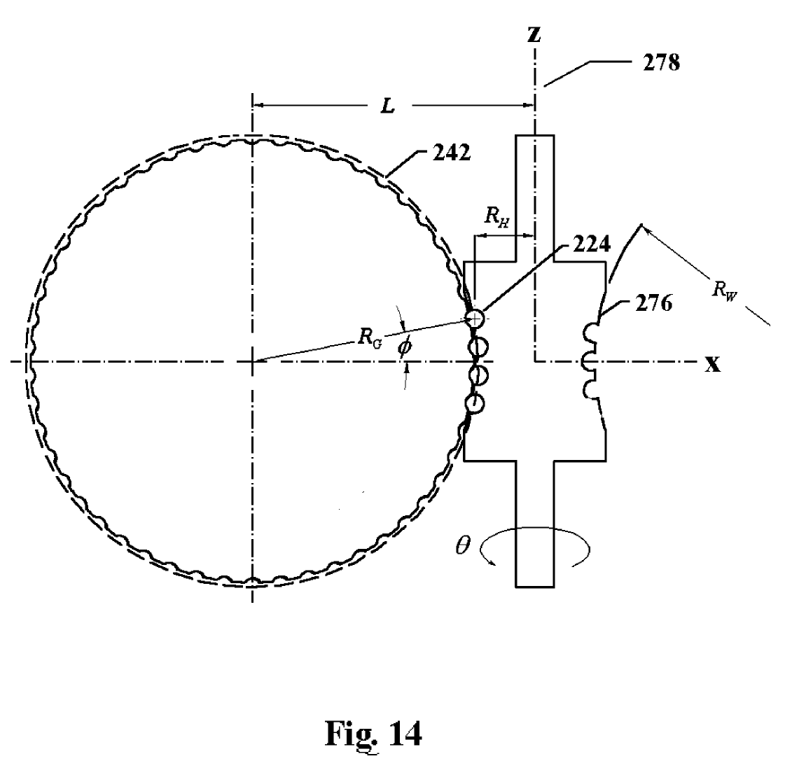

For balls to simultaneously engage multiple gear grooves, the path of the worm helix must be mathematically computed. FIG. 13 shows a general outline of the ball-worm and defines its Cartesian x, y, z, and angular θ coordinates. The origin of the coordinate system is located at the geometric center of the ball-worm. In this coordinate system, worm axis 278 is also the z-axis. FIG. 14 provides a top-down outline view of the ball-worm and gear, and defines the essential parameters necessary to mathematically describe the worm helix. The distance from the center of the gear to center of representative ball 224 along the central plane of the gear is given by R_{G}. R_{G} is also the radius of dashed circular curve 242, which is concentric with the gear and intersects the center of representative ball 224. The worm has an hourglass-shaped outer surface 276 with radius R_{H}. L designates the distance between the gear center and worm axis 278. R_{H} is the distance between worm axis 278 and representative ball 224, and is a function of θ that is given by

$${R}_{H} ( θ ) = L - {R}_{G} cos ( ϕ ) = L - {R}_{G} cos ( \frac{θ}{N} )$$

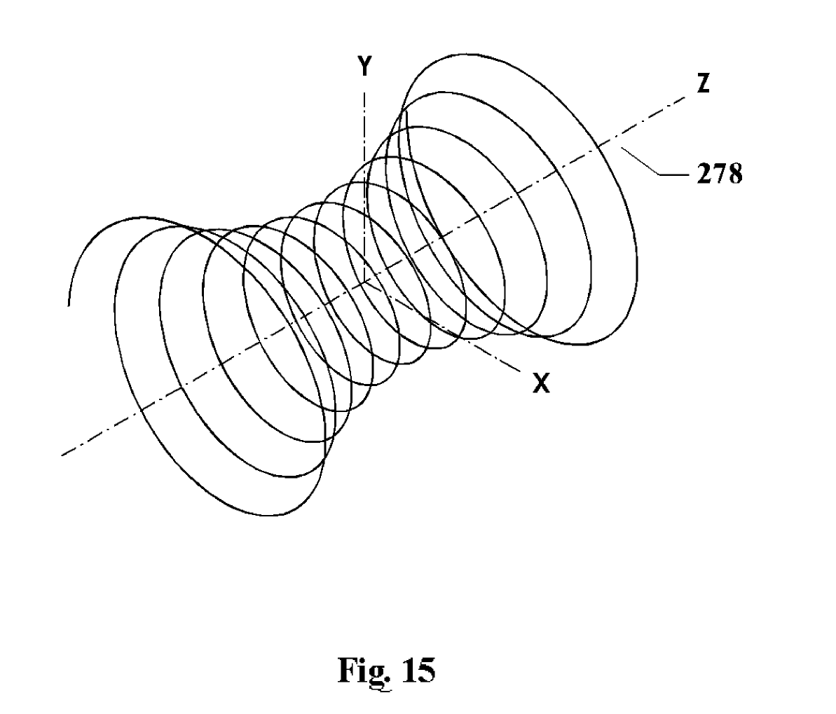

The path of the worm helix Has a function of θ can then be written as

$$H ( θ ) = [ \begin{matrix}{H}_{x} ( θ ) \\ {H}_{y} ( θ ) \\ {H}_{z} ( θ )\end{matrix} ] = [ \begin{matrix}{R}_{H} cos ( θ ) \\ {R}_{H} sin ( θ ) \\ {R}_{G} sin ( θ )\end{matrix} ] = [ \begin{matrix}( L - {R}_{G} cos ( \frac{θ}{N} ) ) cos ( θ ) \\ ( L - {R}_{G} cos ( \frac{θ}{N} ) ) sin ( θ ) \\ {R}_{G} sin ( \frac{θ}{N} )\end{matrix} ]$$

where Hₓ, H_{y}, and H_{z} are the x, y, and z components of helix equation H, and where N is the transmission ratio. FIG. 15 provides a representative plot of the above helix equation.

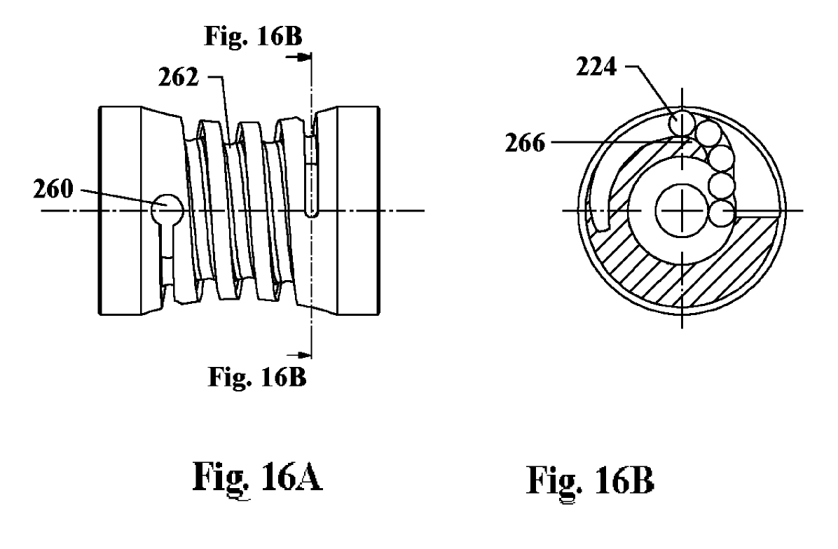

As the balls circulate, passive balls will eventually transition to the recirculating state. Likewise, recirculating balls will eventually transition to the passive state. As shown in FIG. 11B, a transitional port 274 provides a smooth path for balls to enter/exit the passive and recirculating states. The path of transitional port 274 has no sudden turns or sharp edges. FIGS. 16A and 16B provide cross-sectional views of transitional ports 274. The transitional ports comprise a transitional fillet 266 to provide a smooth and stable trajectory for balls to transition to/from the passive and recirculating states.

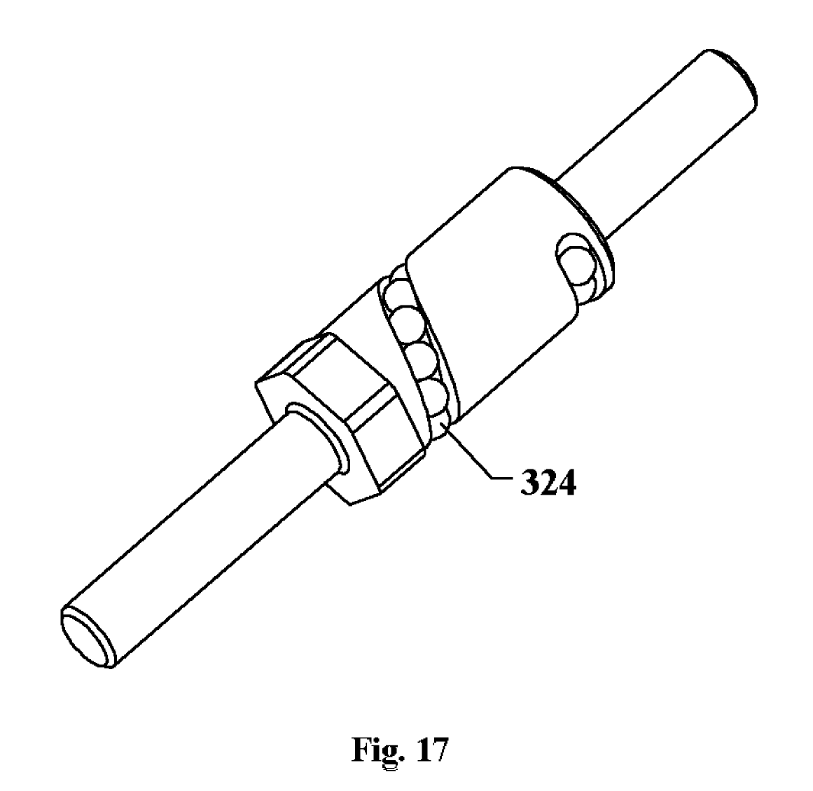

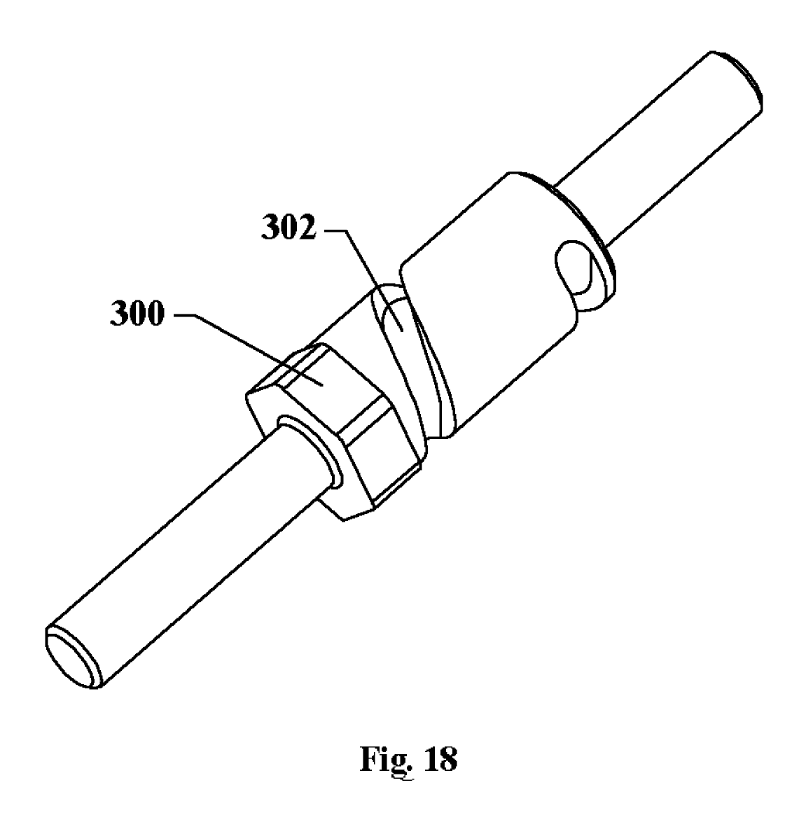

An enlarged view of worm shaft 220 with recirculating balls 324 is shown in FIG. 17. FIG. 18 shows the worm shaft alone. Recirculation channel 302 on worm shaft 220 provides a recirculation path for balls to be recycled. Although the recirculation channel is shown with a U-shaped profile, it can optionally be of any cross-sectional profile or path suitable for balls to smoothly and stably be recycled. Balls in direct contact with the recirculation channel are defined to be in the recirculating state.

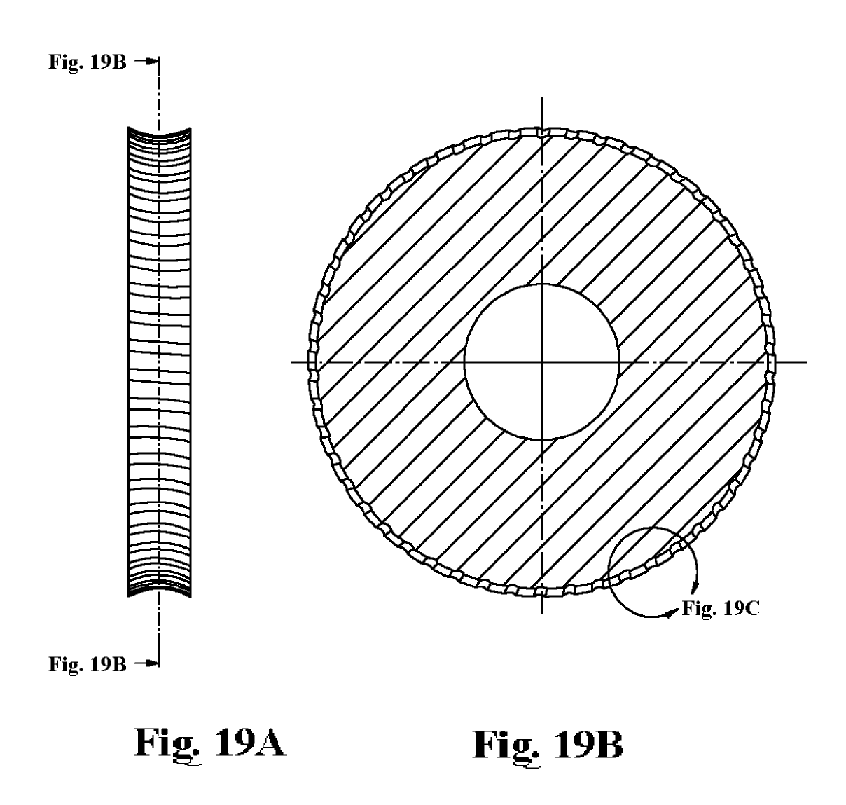

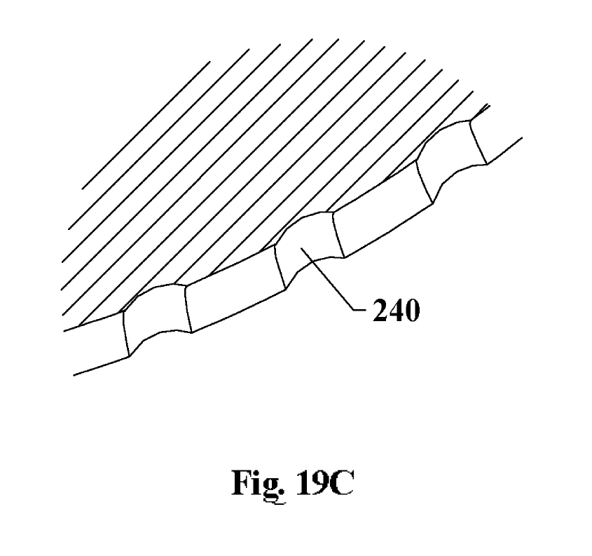

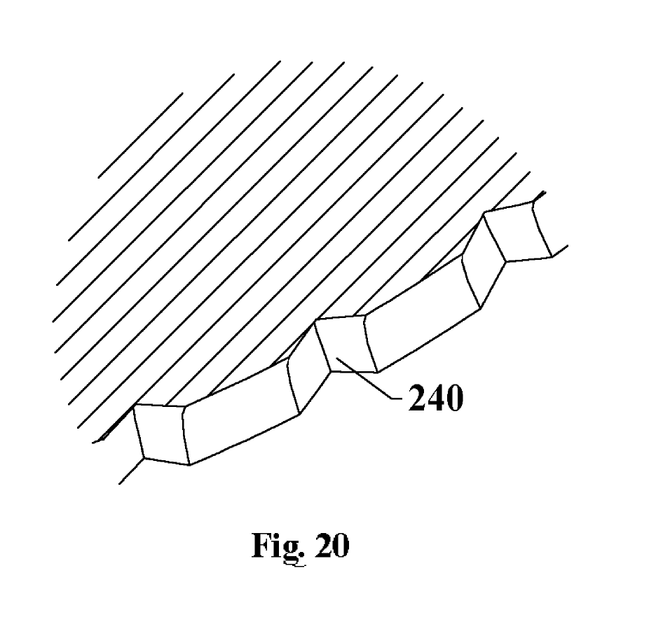

Details of gear 202 are shown in FIGS. 19A through 19C. The cross-sectional profile of the gear grooves is semicircular or partial-circular. The grooves may optionally comprise a slight chamfer (not shown) near the top and bottom faces of the gear to provide the balls a smoother transition to the active state. FIG. 20 shows a gear with alternative V-shaped, or V-notched, profiled gear groove. Any groove profile that will firmly engage the balls while providing a precision rolling surface will suffice. The gear groove profile depicted in FIG. 19C is presently preferred.

### Operation

The manner of using the present invention is identical to prior-art ball-worm transmissions. Rotational motion is exerted on ball-worm 200, which causes gear 202 to rotate as its gear grooves engages the rotating helix of balls. Balls that roll between the worm and the gear become firmly engaged between them, coupling the gear to the worm. Each complete turn of the ball-worm advances the gear by one gear teeth. The circuit of rolling balls significantly reduces frictional forces. Thus, the device is inherently reverse-drivable. That is, rotational motion exerted on the gear can also cause the worm to rotate. If a non-reverse-drivable configuration is desired, additional elements may be added to increase frictional resistance. Sufficient frictional resistance will cause the device to be non-reverse-drivable. The self-retaining feature of the ball-worm greatly simplifies ball installation. The device does not suffer from cumbersome assembly or disassembly that prior-art ball-worm transmissions experience. Rendering all extraneous or external ball-retaining components unnecessary causes the device to be less complex, yet with enhanced durability and wear characteristics.

### ADVANTAGES

From the description above, a number of advantages of the present invention are evident:
(1) The use of balls as rolling elements greatly reduces, or altogether eliminates, sliding friction, and enhances transmission efficiency.
(2) The use of precision balls as rolling elements minimizes, or altogether eliminates, backlash.
(3) The non-backlash characteristics of the device is not bound to a narrow torque range.
(4) The use of rolling elements to replace sliding elements reduces wear and improves durability.
(5) The device is inherently reverse-drivable, but can be configured for non-reverse-drivable applications.
(6) The self-retaining ball-worm obviates the need for any extraneous ball-retaining mechanisms found in prior-art ball-worm transmissions; thus, it requires fewer parts and is less complex than prior-art ball-worm transmissions.
(7) The elimination of extraneous ball-retaining mechanisms that require contact with the balls improves durability and wear characteristics.
(8) The elimination of all extraneous ball-retaining mechanisms reduces cost, weight, and size.
(9) The ball installation process is greatly simplified and convenient, decreasing assembly and maintenance costs.
(10) Simultaneously engagement of multiple gear grooves enhances coupling rigidity between the gear and ball-worm, which increases the torque load capability of the device.

Although the description above contains many specifics, these should not be construed as limiting the scope of the invention but as merely providing illustrations of some of the presently preferred embodiments of the invention. The scope of the invention should be determined by the appended claims and their legal equivalent, rather than by the examples given.

What is claimed is:

1. A rotational transmission comprising:
a. a ball-worm,
b. a gear coupled to said ball-worm, and
c. support means whereby said ball-worm and said gear are axially supported and restrained to their respective axes of motion.

2. The rotational transmission of claim 1 wherein said gear comprises a plurality of gear grooves separated at equal angular intervals.

3. The gear of claim 2 wherein said gear grooves optionally comprise a slight chamfer near the top and bottom faces of said gear whereby balls may smoothly and stably transition to be firmly engaged between the gear grooves and worm.

4. The rotational transmission of claim 1 wherein said ball-worm comprises:
a. a worm shaft
b. a worm collar concentrically and rigidly fastened to said worm shaft,
c. a plurality of balls, and
d. a plug.

5. The ball-worm of claim 4 wherein said worm collar comprises an alignment pocket.

6. The ball-worm of claim 4 wherein said worm shaft comprises an alignment boss whereby said worm collar and said worm shaft are aligned and mated when fastened.

7. The ball-worm of claim 4 wherein said worm shaft comprises a recirculation channel whereby balls may be recycled within said ball-worm.

8. The rotational transmission of claim 1 wherein said ball-worm comprises a helix profile that is capable of retaining balls, whereby balls are constrained to said ball-worm.

9. The rotational transmission of claim 1 wherein said ball-worm comprises a mathematically accurate helix whereby balls of said ball-worm simultaneously engage multiple gear grooves.

10. The rotational transmission of claim 1 wherein said ball-worm comprises at least one opening, or ball installation port, whereby balls may be conveniently installed into said ball-worm.

11. The rotational transmission of claim 1 wherein said ball-worm may be composed of, or consist, a permanent magnet whereby magnetism is used to assist ball retention.

12. The rotational transmission of claim 1 wherein said ball-worm defines a circuit path whereby balls may traverse and recirculate.

13. The rotational transmission of claim 1 wherein said ball-worm comprises at least one transitional port whereby balls may stably and smoothly transitioning to/from the recirculating state.

14. A rotational transmission comprising:
a. a ball-worm having a worm shaft and worm collar which are concentrically and rigidly fastened, and which together define a ball circulation path,
b. wherein said ball-worm comprises a plurality of balls free to traverse within the ball circulation path of said ball-worm,
c. wherein said ball-worm comprises a helix with cross-sectional geometry suitable for retaining said balls and constraining them to said ball-worm,
d. at least one ball installation port built into the worm collar of said ball-worm,
e. at least one helical recirculation channel built into said worm shaft,
f. at least one transitional port comprising a fillet built into the worm collar of said ball-worm whereby balls may smoothly and stably enter/exit said recirculation channel, and
g. a gear coupled to said ball-worm via said plurality of balls.

15. The rotational transmission of claim 14 wherein the worm shaft and worm collar may optionally be composed of a permanently magnetized material.
